(19) United States
(12) Patent Application Publication
(10) Pub. No.: US 2018/0371141 A1
(43) Pub. Date: Dec. 27, 2018

(54) RUBBER COMPOSITION COMPRISING A FUNCTIONAL DIENE POLYMER

(71) Applicant: COMPAGNIE GENERALE DES ETABLISSEMENTS MICHELIN, Clermont-Ferrand (FR)

(72) Inventors: Anne-Lise THUILLIEZ, Clermont-Ferrand Cedex 9 (FR); Odile GAVARD-LONCHAY, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/775,342

(22) PCT Filed: Nov. 3, 2016
(86) PCT No.: PCT/FR2016/052844

§ 371 Date: May 10, 2018

(30) Foreign Application Priority Data
Nov. 13, 2015 (FR) 1560849

(51) Int. Cl. C08F 236/08; C08F 236/06; C08L 7/00; B60C 1/00

(52) U.S. Cl. CPC C08F 236/08; C08F 236/06; B60C 2001/0066; B60C 1/0041; C08L 7/00

(57) ABSTRACT

The present invention relates to a rubber composition based on at least one polymer matrix comprising a diene elastomer Ed and a functional diene polymer that carries at least one aromatic group substituted by at least two hydroxyl functions. The diene elastomer Ed represents more than 50% by mass of the polymer matrix, the functional diene polymer represents at most 30% by mass of the polymer matrix and two of the hydroxyl functions are vicinal. Such a composition presents good adhesive properties for metal reinforcement elements that can be used in a reinforcing reinforcer for tires.

This application is a 371 national phase entry of PCT/FR2016/052844, filed 3 Nov. 2016, which claims benefit of French Patent Application No. 1560849, filed 13 Nov. 2015, the entire contents of which are incorporated herein by reference for all purposes.

### BACKGROUND

### 1. Technical Field

The present invention relates to the field of rubber compositions, particularly intended for use in a semi-finished rubber article including metal strengthening elements. More particularly, the invention concerns rubber compositions usable in the production of reinforcement structures or reinforcers for vehicle tires.

### 2. Related Art

Metal/rubber composites, in particular for tires, are well known. These are generally constituted by a diene rubber matrix, crosslinkable, including strengthening elements generally in the form of thread(s) or assemblies of threads. They may be used in a tire, for example as radial carcass reinforcement, such as carcass plies or crown plies.

In a known way, a tire with radial carcass reinforcement comprises a tread, two inextensible beads, two sidewalls connecting the beads to the tread and a belt positioned circumferentially between the carcass reinforcement and the tread, this belt and the carcass reinforcement consisting of various plies (or “layers”) of rubber, reinforced by reinforcing elements or reinforcers such as cables or monofilaments, for example made of metal. A reinforcement ply reinforced with thread elements is therefore constituted of a gum and reinforcement elements that are embedded in the gum. The gum is generally based on a diene elastomer, natural rubber, a reinforcing filler such as carbon black, a crosslinking system based on sulfur and zinc oxide. The reinforcement elements are arranged practically parallel to each other inside the ply.

In order to effectively fulfil their function of reinforcing these plies, which are subjected in a known way to very high stresses during running of the tires, these metal thread reinforcing elements must satisfy a very high number of often contradictory technical criteria, such as high endurance in fatigue, high tensile strength, wear resistance and corrosion resistance, strong adhesion to the surrounding rubber, and be capable of maintaining this performance at a very high level for as long as possible.

It is easily understood that the adhesion between the gum and the metal thread reinforcing elements is therefore a key property in the endurance of this performance.

For example, the traditional process for connecting the gum to the steel consists in coating the steel's surface with brass (copper-zinc alloy), the bond between the steel and the gum being ensured by sulfuration of the brass during vulcanization or curing of the elastomer present in the gum. In point of fact, it is known that the adhesion between the steel and the gum is capable of weakening over time as a result of the gradual development of sulfides formed under the effect of the various stresses encountered, especially mechanical and/or thermal stresses.

Moreover, the metal reinforcement elements can be made of a metal other than steel or be covered by a metal other than steel such as aluminium, cobalt, copper, tin, nickel, zinc or alloys thereof. It is also of economic interest to have a material that can adhere not only to steel, but also to other metals.

It is also known to use adhesive systems or glues that ensure good bonding between the metal and the rubber in metal/rubber composites. Using a glue generally passes by the application of the glue on the metal before the composite is manufactured. This operation of depositing glue in the metal requires specific, clean facilities for the application of the glue, in particular baths, in the manufacturing line of the composite. These facilities have the drawback of taking up space and representing a cost. It may also occur that the glue deposit is not uniform over the entire metal surface, which can cause heterogeneities in the composite's final properties. Therefore there is interest in removing recourse to a glue in the manufacturing of such composites to avoid these drawbacks.

Therefore tire manufacturers are constantly preoccupied with finding rubber compositions that not only exhibit good adhesion, but also do not exhibit the drawbacks stated previously.

### SUMMARY

During their research, the Applicants have discovered that the introduction of at most 30% by mass of a diene polymer carrying at least one group of the dihydroxyaryl type in a polymer matrix contained in a diene rubber composition solves the drawbacks stated above.

From patent application WO2009086490, it is known to use in a rubber composition a diene polymer carrying aromatic groups substituted by hydroxyl functions to reduce the hysteresis properties of the rubber composition to reduce the rolling resistance of a tire. Patent application WO2011002994 discloses a polymer synthesis process carrying aryl groups substituted by at least two hydroxyl functions and optionally hydrolysable OR functions. These polymers can be used in rubber compositions for tire treads to reduce hysteresis. But none of these requests discloses that the use of at most 30% by mass of a diene polymer carrying one or more aromatic groups substituted by at least two vicinal hydroxyl functions in a diene elastomer matrix that further carries more than 50% by mass of a diene elastomer and that is contained in a rubber composition improves the bond between a metal and the rubber composition, and the hydroxyl functions are vicinal.

Accordingly, a first subject of the present invention is a rubber composition containing at least one polymer matrix comprising a diene elastomer Ed and a functional diene polymer that carries at least one aromatic group substituted by at least two hydroxyl functions, where the diene elastomer Ed represents more than 50% by mass of the polymer matrix, characterized in that the functional diene polymer represents at most 30% by mass of the polymer matrix and two of the hydroxyl functions are vicinal.

A further subject of the invention is a semi-finished article including reinforcement elements with a metallic surface intended to come into contact with the rubber composition, where the reinforcement elements are coated in the rubber composition in accordance with the invention.

The invention also relates to a tire comprising a semi-finished article in accordance with the invention.

### I. DETAILED DESCRIPTION OF EXAMPLE EMBODIMENTS

In the present description, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

In the present description, unless expressly indicated otherwise, all the percentages (%) shown are % by mass.

The expression composition “based on” should be understood as meaning, in the present description, a composition comprising the mixture and/or the in situ reaction product of the various constituents used, some of these base constituents (for example the elastomer, the filler or other additive conventionally used in a rubber composition intended for the manufacture of tires) being capable of reacting or intended to react with one another, at least in part, during the various phases of manufacture of the composition intended for the manufacture of tires.

In the present application, the name “aromatic group” denotes the aromatic group that is substituted by at least the two vicinal hydroxyl functions defined according to embodiments of the invention and that is carried by the functional diene polymer useful for the needs of the invention according to any one of its embodiments.

In this application, the hydroxyl function refers to the OH group.

Polymer matrix is intended to mean all the polymers (i.e. macromolecular chains) present in the rubber composition.

The essential characteristic of the polymer matrix is a functional diene polymer that carries at least one aromatic group, where the aromatic group is substituted by at least two hydroxyl functions, and two of the hydroxyl functions are vicinal.

Two vicinal functional groups is understood to mean two functional groups that are carried by carbons of the aromatic ring that are adjacent. In other words, one hydroxyl functional group is in the ortho position with respect to the other hydroxyl functional group.

According to a specific embodiment of the invention, the functional diene polymer carries several aromatic groups substituted by at least two hydroxyl functions, where two of the hydroxyl functions are vicinal.

In a preferred manner, there are two hydroxyl functions of the aromatic group.

According to any one of the embodiments of the invention, the two vicinal hydroxyl functions are preferably respectively in the meta and para positions relative to the bond or the group that ensures the attachment of the aromatic group to the chain, specifically the main chain, of the functional diene polymer.

The relative position of the hydroxyl functions on the aromatic group, i.e. vicinal, confers good adhesion properties to the metal to the rubber composition.

According to a particularly preferred embodiment of the invention, the aromatic group is a dihydroxyaryl group having formula (I) wherein the symbol * represents a direct or indirect attachment to the chain, specifically the main chain, of the functional diene polymer.

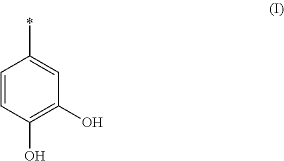 [SMILES: *c1ccc(O)c(O)c1]

It should be remembered that diene polymer should be understood as meaning a polymer that comprises diene units and that is generally made at least in part (i.e. a homopolymer or a copolymer) from diene monomers (monomers carrying two conjugated or non-conjugated carbon-carbon double bonds).

Diene polymer is understood more particularly to mean:

(a) any homopolymer of a conjugated diene monomer having from 4 to 12 carbon atoms;
(b) any copolymer of a conjugated diene monomer, in particular any copolymer of a conjugated diene monomer and of a vinyl monomer, such as ethylene, an α-monoolefin, a methacrylate, a carboxylic acid vinyl ester, vinyl alcohol, a vinyl ether, the conjugated diene monomer having from 4 to 12 carbon atoms;
(c) any homopolymer of a non-conjugated diene monomer having from 5 to 12 carbon atoms;
(d) any copolymer of a non-conjugated diene monomer, in particular any copolymer of a non-conjugated diene monomer and of a monoolefin, such as ethylene or an α-monoolefin, the non-conjugated diene monomer having from 5 to 12 carbon atoms;
(e) a mixture of the polymers defined in (a) to (d).

The following are especially suitable as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

As α-monoolefin, mention may be made of alkenes and vinylaromatic compounds, in particular those having from 8 to 20 carbon atoms, such as for instance styrene, ortho-, meta-, para-methylstyrene.

Suitable as non-conjugated dienes are, for example, those having from 5 to 12 carbon atoms, such as, in particular, 1,4-hexadiene, vinylnorbornene, ethylidenenorbornene, norbornadiene and dicyclopentadiene.

Suitable as (meth)acrylonitrile are acrylonitrile and methacrylonitrile.

Mention may be made, as (meth)acrylates, that is to say acrylates or methacrylates, of acrylic esters derived from acrylic acid or methacrylic acid with alcohols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate, isobutyl methacrylate, glycidyl acrylate and glycidyl methacrylate.

Mention may be made, as vinyl esters of carboxylic acids, for example, of vinyl acetate and vinyl propionate, preferably vinyl acetate.

Suitable as vinyl ethers are, for example, those for which the R group of the ether functional group OR contains from 1 to 6 carbon atoms.

In this application, the diene polymer is called functional since it carries at least one aromatic group that is substituted by two hydroxyl functions.

Preferably, the functional diene polymer is selected from the group of polymers constituted by polybutadienes, polyisoprenes, 1,3-butadiene copolymers, isoprene copolymers and mixtures thereof. As 1,3-butadiene or isoprene copolymers, mention may in particular be made of those resulting from the copolymerization of 1,3-butadiene or isoprene with styrene or (meth)acrylate, in particular glycidyl acrylate or methacrylate. The person skilled in the art understands well that polybutadienes, polyisoprenes, 1,3-butadiene copolymers, isoprene copolymers useful for the needs of the invention as functional diene polymer carry one or more aromatic groups as defined according to any one of the embodiments of the invention.

According to any one of the embodiments of the invention, the diene units in the functional diene polymer preferably represent more than 50%, more preferably more than 70% by mass of the functional diene polymer.

According to any one of the embodiments of the invention, the aromatic group carried by the functional diene polymer is preferably a pendant group of the polymer chain of the functional diene polymer.

The aromatic group carried by the functional diene polymer may be at the end of the polymer chain of the functional diene polymer or outside the ends of the polymer chain of the functional diene polymer.

According to one specific embodiment of the invention, the aromatic group is exclusively carried at the chain end of the polymer chain of the functional diene polymer, particularly on a single end or on each end of the polymer chain of the functional diene polymer.

The functional diene polymer can be synthesized by methods known to the person skilled in the art. For example, mention may be made in a non-limiting way of:
The modification of diene polymers carrying at least one aromatic group substituted by at least two vicinal OR functions that can be hydrolysed by deprotection of the functions as described in patent applications WO2009/086490 A2 and WO2011/002994 A2, where R represents a carbon chain;
The modification of epoxidized diene polymers or the change of diene polymers carrying at least one epoxy pendant group by a nucleophilic compound both carrying the aromatic group substituted by at least two vicinal hydroxyl functions and carrying a nucleophilic function as for instance described in the patent applications filed under numbers FR14/60290 and FR14/60620;
The modification of diene polymers carrying at the chain end a nucleophilic group by a compound both carrying the aromatic group substituted by at least two vicinal hydroxyl functions and carrying a electrophilic group as described for instance in the patent application filed under number FR15/577707.

The preparation method for the functional diene polymer is chosen by the person skilled in the art carefully so that the aromatic group is at the end of the chain of the functional diene polymer or outside its chain ends, depending on the macrostructure of the functional diene polymer, in particular the value of its number-average molar mass and its polydispersity index, and according to the microstructure of the functional diene polymer, in particular respective contents of 1,4-cis, 1,4-trans and 1,2 bonds of the diene portion of the functional diene polymer.

The aromatic group content in the functional diene polymer varies preferably from 0.01 to 3 milliequivalents per g (meq/g), more preferably from 0.15 to 2 meq/g, even more preferably from 0.3 to 1.5 meq/g of functional diene polymer. These ranges may apply to any one of the embodiments of the invention.

According to one of the embodiments of the invention, the functional diene polymer is an elastomer. When it is an elastomer, the functional diene polymer preferably exhibits a number-average molar mass greater than 80,000 g/mol.

According to another embodiment of the invention, the functional diene polymer has a number-average molar mass ranging from 1,000 g/mol to 80,000 g/mol, preferably from 1,000 to 30,000 g/mol, more preferably from 1,000 to 10,000 g/mol, even more preferably from 1,000 to 5,000 g/mol. Generally, these number-average molar masses, particularly the lowest, may be too low depending on the microstructure of the functional diene polymer to give it elastomer properties.

The polymer matrix has another essential characteristic of comprising another polymer, a diene elastomer Ed, different from the functional diene polymer. It is understood that the diene elastomer Ed does not meet the definition of the functional diene polymer. Preferably, the diene elastomer Ed is devoid of the aromatic group carrying the two vicinal hydroxyl groups. The preferred embodiment whereby diene elastomer Ed is devoid of the aromatic group carrying the two vicinal hydroxyl groups can be applied to any one of the embodiments of the invention. Diene elastomer is understood to mean one or more diene elastomers that are differentiated by their microstructure or macrostructure. Diene elastomer Ed represents more than 50% by mass of the polymer matrix to confer upon the polymer matrix the rubbery character of the rubber composition.

Diene elastomer (or alternatively “rubber”, where the two terms are considered to be synonymous), must be understood in the known manner as a diene polymer as defined above in terms of its microstructure.

Diene elastomers can be classified into two categories: “essentially unsaturated” or “essentially saturated”. “Essentially unsaturated” is understood to mean generally a diene elastomer resulting at least in part from conjugated diene monomers having a content of units of diene origin (conjugated dienes) which is greater than 15% (mol %); thus, diene elastomers such as butyl rubbers or copolymers of dienes and of α-olefins of EPDM type do not fall under the preceding definition and may especially be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

The diene elastomer Ed can be star-branched, coupled, functionalized or non-functionalized, in a way known per se, by means of functionalization agents, coupling agents or star-branching agents known to a person skilled in the art.

According to any one of the embodiments, the diene elastomer Ed is preferably a highly unsaturated diene elastomer, in the most preferred manner selected from the group of highly unsaturated elastomers constituted of polybutadienes, polyisoprenes, 1,3-butadiene copolymers, isoprene copolymers and mixtures thereof. In an even more preferred manner, the diene elastomer Ed is a polyisoprene with more than 90% by mass of 1,4-cis bonding. Better, the diene elastomer is natural rubber.

As for the functional diene polymer, it represents at most 30% by mass of the polymer matrix, preferably between 5 and 30% by mass of the polymer matrix. Above 30%, the intrinsic properties of diene elastomers are lost, which confer on the rubber composition its properties, such as elasticity, cohesion, green tack, crystallization under tension depending on the microstructure and the macrostructure of the diene elastomer Ed. Below 5%, the improved adhesion properties may be insufficient depending on the application envisaged of the rubber composition.

According to one embodiment of the invention, the diene elastomer Ed and the functional diene polymer represent at least 90% by mass of the polymer matrix. Better, the polymer matrix consists of the functional diene polymer and the diene elastomer Ed.

According to one particularly preferred embodiment of the invention, the rubber composition comprises a reinforcing filler.

The reinforcing filler is generally used to improve for example cohesion or rigidity of the polymer matrix. The reinforcing filler is a filler known for its ability to reinforce a polymer matrix containing a diene polymer, more particularly an elastomer. The reinforcing filler is typically a reinforcing filler conventionally used in rubber compositions that can be used for the manufacture of tires. The reinforcing filler is, for example, an organic filler such as carbon black, an inorganic reinforcing filler such as silica, with which a coupling agent is combined in a known manner, or else a mixture of these two types of filler. The reinforcing filler is preferably carbon black.

Such a reinforcing filler typically consists of nanoparticles, the (weight-)average size of which is less than a micrometre, generally less than 500 nm, most commonly between 20 and 200 nm, in particular and more preferentially between 20 and 150 nm.

All carbon blacks, especially the blacks conventionally used in tires or their treads (“tire-grade” blacks), are suitable as carbon blacks. Among the latter, mention will more particularly be made of the reinforcing carbon blacks of the 100, 200 and 300 series, or the blacks of the 500, 600 or 700 series (ASTM grades), such as, for example, the N115, N134, N234, N326, N330, N339, N347, N375, N550, N683 and N772 blacks. These carbon blacks may be used on their own, as available commercially, or in any other form, for example as support for some of the rubber-making additives used.

The reinforcing filler content is selected by the person skilled in the art depending on the application envisaged for the composite and on the nature of the reinforcing filler, in particular the value of its BET specific surface area. For example, for an application of the composition in the tire, in particular as a reinforcement structure or reinforcer in the tire, the reinforcing filler content is preferably within a range extending from 20 to 80 parts per hundred parts of polymer matrix. Below 20 parts, the reinforcement of the polymer matrix may be insufficient.

Above 80 parts, there is a risk of increased hysteresis of the polymer matrix that may cause the composition to heat, which may lead to performance degradation in the composition.

According to one particularly preferred embodiment of the invention, the rubber composition comprises a crosslinking system for the polymer matrix. During manufacturing of the composite, the crosslinking system is intended to react to cause crosslinking of the polymer matrix, generally after the reinforcement elements are put into contact with the polymer matrix containing the crosslinking system and optionally the reinforcing filler and after its shaping. The crosslinking also generally improves the elastic properties of the polymer matrix. The crosslinking system can be a vulcanization system or be based on one or more peroxide compounds, for example conventionally used in rubber compositions that can be used for the manufacture of tires.

The vulcanization system proper is based on sulfur (or on a sulfur-donating agent) and generally on a primary vulcanization accelerator. Various known secondary vulcanization accelerators or vulcanization activators, such as zinc oxide, stearic acid or equivalent compounds, or guanidine derivatives (in particular diphenylguanidine), may for example be added to this base vulcanization system, being incorporated during the first non-productive phase and/or during the productive phase, as described subsequently. Sulfur is used at a preferential content ranging from 0.5 to 12 parts per hundred, in particular from 1 to 10 parts per hundred parts of the polymer matrix. The primary vulcanization accelerator is used at a preferential content of between 0.5 and 10 parts per hundred parts of the polymer matrix, more preferentially of between 0.5 and 5 parts per hundred parts of the polymer matrix. Use may be made, as (primary or secondary) accelerator, of any compound capable of acting as accelerator for the vulcanization of diene polymers, particularly diene elastomers, in the presence of sulfur, especially accelerators of thiazole type, and also their derivatives, and accelerators of thiuram and zinc dithiocarbamate types. Use is preferably made of a primary accelerator of the sulfenamide type.

When the chemical crosslinking is carried out using one or more peroxide compounds, said peroxide compound or compounds represent from 0.01 to 10 parts per hundred parts of the polymer matrix. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition may also include all or part of the usual additives habitually dispersed in polymer matrices containing a diene polymer, particularly an elastomer. The person skilled in the art selects the additives and their content according to the application envisaged of the rubber composition. For example, for an application of the rubber composition in the tire, in particular in a reinforcement structure or reinforcer in the tire, as additives mention may be made of pigments, protection agents such as anti-ozone waxes, chemical antiozonants, antioxidants, plasticizers or delivery agents.

The first non-productive phase and the productive phase are mechanical working steps, in particular kneading, well known to the person skilled in the art in manufacturing rubber compositions. The first non-productive phase is generally distinguished from the productive phase in that the mechanical work is conducted at high temperature, up to a maximum temperature of between 110° C. and 190° C., preferably between 130° C. and 180° C. The productive phase that follows the non-productive phase, generally after a cooling step, is defined by mechanical working at lower temperature, typically below 110° C., for example between 40° C. and 100° C., during which finishing phase the crosslinking system is incorporated.

The reinforcing filler, the crosslinking system and the additives are generally distributed in the polymer matrix by their incorporation into the polymer matrix. For example, the reinforcing filler may be incorporated into the polymer matrix by mechanical mixing, particularly thermomechanical mixing, optionally in the presence of the previously cited additives. The mixing temperature is selected carefully by the person skilled in the art depending on the thermal sensitivity of the polymer matrix, its viscosity and the nature of the reinforcing filler. The crosslinking system is incorporated into the polymer matrix typically at a temperature lower than the temperature at which crosslinking occurs to allow its dispersion in the polymer matrix and later shaping of the composite before the crosslinking of the polymer matrix. Generally, the crosslinking system is incorporated in the polymer matrix after the incorporation of the reinforcing filler and other additives in the polymer matrix.

The rubber composition can be used in a semi-finished article including reinforcement elements coated in the rubber composition of embodiments of the invention, whose reinforcement elements have a metallic surface intended to come into contact with the rubber composition. Preferably the reinforcement elements are arranged generally side by side according to a main direction. For an application envisaged in the tire, the semi-finished article is preferably a crown reinforcement for tires, such as a carcass reinforcement or a crown reinforcement.

The reinforcement elements (also called reinforcers) have the essential characteristic of having a metallic surface. The metallic surface of each reinforcer may be all or part of the total surface of the reinforcer and is intended to come into contact with the rubber composition of embodiments of the invention.

Only one part of the reinforcer is metallic, this part being by definition of embodiments of the invention at least constituted of the metallic surface as defined previously, or it is the entirety of the reinforcer that is metallic. Preferably the entire reinforcer is made of metal.

According to a first variant of the invention, the metallic surface of the reinforcer is made of a material other than the remainder of the reinforcer. In other words, the reinforcer is made of a material that is coated entirely or in part by a metal coating that constitutes the metallic surface. The material coated in whole or in part by the metallic surface is metallic or non-metallic, preferably metallic.

According to a second variant of the invention, the reinforcer is made of a single material, in which case the reinforcer is made of a metal that is identical to the metal of the metallic surface.

These two variants apply to any one of the embodiments of the invention concerning the semi-finished article.

According to an advantageous embodiment of the invention, the metallic surface comprises iron, copper, zinc, tin, aluminium, cobalt or nickel.

According to a particularly preferred embodiment of the invention, the metal of the metallic surface is a metal selected from the group constituted by iron, copper, zinc, tin, aluminium, cobalt, nickel and alloys including at least one of these metals. The alloys may for example be binary or ternary alloys such as steel, bronze and brass. Preferably, the metal of the metallic surface is iron, copper, tin, zinc or an alloy including at least one of these metals. In a more preferred manner, the metal of the metallic surface is steel, brass (Cu—Zn alloy) or bronze (Cu—Sn alloy).

In this application, the expression “the metal of the metallic surface is the metal denoted hereinafter” means that the metallic surface is made of the metal denoted hereinafter. For example the expression “the metal of the metallic surface is iron” written above means that the metallic surface is made of iron. Some metals are subject to oxidation on contact with ambient air, so the metal can be partially oxidized with the exception of stainless steel.

When the metallic surface is made of steel, the steel is preferably a carbon steel or a stainless steel. When the steel is a carbon steel, its carbon content is preferably inclusively between 0.01% and 1.2% or between 0.05% and 1.2%, or also between 0.2% and 1.2%, in particular between 0.4% and 1.1%. When the steel is stainless, it preferably includes at least 11% chromium and at least 50% iron.

The reinforcer may be presented in different forms, preferably in the form of an individual thread (monothread) or an assembly of threads, whether these threads are twisted together (for example, in the form of a cable) or essentially parallel.

In the semi-finished article and the tire of embodiments of the invention, the reinforcer is presented more preferably in the form of an individual thread or an assembly of threads, for example of a cable or a strand manufactured with devices and cabling or stranding processes known to the person skilled in the art, which are not described here for the simplicity of the description.

When the composites of embodiments of the invention are used to reinforce carcass or crown reinforcements for radial tires, the reinforcers used are preferably assemblies (strands or cables) of thin carbon steel or stainless steel threads having:
a tensile strength greater than 2,000 MPa, more preferably greater than 2,500 MPa, particularly greater than 3,000 MPa; the person skilled in the art knows how to manufacture fine threads having this strength, by adjusting in particular the composition of the steel and the final work-hardening contents of these threads;
for a good strength/bending strength/feasibility compromise, a diameter inclusively between 0.10 and 0.40 mm, more preferably between approximately 0.10 and 0.30 mm when the composite is intended to reinforce a carcass reinforcement, between approximately 0.20 and 0.40 mm when the composite is intended to reinforce a crown reinforcement.

Each of the embodiments defining the reinforcer applies to any one of the embodiments of the semi-finished article.

The semi-finished article can be manufactured by a process that comprises the following steps:
Making two layers of the rubber composition,
Taking each reinforcement element as a sandwich in the two layers, by depositing it between the two layers,
If appropriate, cure.

The layers may be made by calendaring. During curing of the semi-finished article, the polymer matrix is crosslinked, in particular by vulcanization or by peroxides.

When the semi-finished article is intended to be used as a reinforcement in a tire, the curing of the semi-finished article generally takes place during the curing of the tire casing.

The embodiments of the invention relate to the rubber composition, the semi-finished article and the green tire (before crosslinking of the polymer matrix) or cured tire (after crosslinking of the polymer matrix).

The abovementioned characteristics of embodiments of the present invention, and also others, will be better understood on reading the following description of several exemplary embodiments of the invention, given by way of illustration and without limitation.

### II. EXAMPLES

### II.1—Preparation of Functional Diene Polymers Useful for the Needs of Embodiments of the Invention:

### Proton NMR Analysis:

Proton NMR analysis is used to determine the microstructure of the polymers used or synthesized. The content of the 3,4-dihydroxyaryl group in the functional diene polymer is given as a molar percentage (mol %, i.e. per 100 moles of monomer unit of the diene polymer) or as milliequivalent per gram of functional diene polymer (meq/g).

The spectra are acquired on a Bruker 500 MHz spectrometer equipped with a 5 mm BBI z-grad “broad band” probe. The quantitative ¹H NMR experiment uses a simple 30° pulse sequence and a repetition time of 3 seconds between each acquisition. The samples are dissolved in deuterated chloroform (CDCl₃) or deuterated methanol (MeOD).

### Sec Analysis:

Size exclusion chromatography (SEC) is used. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards and the polymolecularity or polydispersity index (PI=Mw/Mn) can be calculated via a “Moore” calibration.

Preparation of the polymer: There is no specific treatment of the polymer sample before analysis. The latter is simply dissolved in tetrahydrofuran (THF) that contains 1 vol % of diisopropylamine, 1 vol % of triethylamine and 0.1 vol % of distilled water, at a concentration of approximately 1 g/L. The solution is then filtered through a filter with a porosity of 0.45 μm before injection.

SEC analysis: The apparatus used is a Waters Alliance chromatograph. The elution solvent is tetrahydrofuran that contains 1 vol % of diisopropylamine and 1 vol % of triethylamine. The flow rate is 0.7 mL/min, the temperature of the system is 35° C. and the analytical time is 90 min. A set of four Waters columns in series, with commercial names Styragel HMW7, Styragel HMW6E and two Styragel HT6E, is used.

The volume of the solution of the polymer sample injected is 100 μl. The detector is a Waters 2410 differential refractometer and the software for making use of the chromatographic data is the Waters Empower system.

The calculated average molar masses are relative to a calibration curve produced from PSS Ready Cal-Kit commercial polystyrene standards.

II.1.1—by Modifying an Isoprene and Glycidyl Methacrylate Copolymer Through Reaction with a Nucleophilic Compound Carrying Both the 3,4-Dihydroxyaryl Group and Carrying a Nucleophilic Function, 3,4-Dihydroxyhydrocinnamic Acid:

In advance, the isoprene and glycidyl methacrylate copolymers A, B and C are prepared by free-radical polymerization according to the following protocol:

The glycidyl methacrylate (MAGLY), isoprene, toluene and azobisisobutyronitrile (AIBN) are introduced under a stream of argon into an autoclave reactor. The reaction mixture is heated to and stirred at a temperature T and for a duration t. At the end of polymerization, the copolymer is precipitated in methanol. The copolymer is analysed by ¹H NMR. For each of the copolymers, the quantities of reagents and solvent, the temperature T and the duration t are indicated in Table 1a.

TABLE 1a

| | | | |
|---|---|---|---|
| Copolymer | A | B | C |

| | | | | | | |
|---|---|---|---|---|---|---|
| MAGLY | 30.0 | g | 17.0 | g | 20.0 | g |
| isoprene | 129.2 | g | 73.2 | g | 86.1 | g |
| toluene | 100.0 | g | 100.0 | g | 70.0 | g |
| AIBN | 3.67 | g | 4.16 | g | 3.67 | g |
| T | 70° | C. | 70° | C. | 70° | C. |
| t | 960 | min | 1200 | min | 960 | min |

Table 1b indicates the microstructure of copolymers A, B and C prepared, expressed in molar percentage.

TABLE 1b

| Copolymer | A | B | C |
|---|---|---|---|
| MAGLY | 12 | 14 | 12 |
| isoprene | 88 | 86 | 88 |

Copolymer A or B or C is then modified by reaction with a compound carrying a 3,4-dihydroxyaryl group, 3,4-dihydroxyhydrocinnamic acid according to the following protocol:

In a single-necked round-bottomed flask with an attached condenser, the isoprene and glycidyl methacrylate copolymer (A or B or C) is solubilized in dioxane. The 3,4-dihydroxyhydrocinnamic acid is added. Then the reaction medium is stirred with magnetic stirring and heated for 72 hours at 120° C. The reaction medium is then left to return to ambient temperature, then the polymer is coagulated in water, filtered, then solubilized again in dichloromethane to be dried over Na₂SO₄. The solution is then evaporated to dryness.

For each of copolymers A and B and C of isoprene and glycidyl methacrylate, the quantities of reagents and solvents used in the reaction to modify the copolymer by 3,4-dihydroxyhydrocinnamic acid are indicated in Table 2. Also in Table 2 are the microstructure and macrostructure of the modified copolymer AF and BF and CF respectively.

TABLE 2

| Functional diene polymer | AF | BF | CF |
|---|---|---|---|
| Copolymer A | 50.0 g | 0 | 0 |
| Copolymer B | 0 | 42.4 g | 0 |
| Copolymer C | 0 | 0 | 30.3 g |
| 3,4-dihydroxyhydrocinnamic acid | 16.1 g | 10.9 g | 9.74 g |
| dioxane | 200.0 g | 65.0 g | 100.0 g |
| Mn | 7800 | 4700 | 5000 |
| Mw | 30800 | 9160 | 9500 |
| 3,4-dihydroxyaryl group | | | |
| (mol %) | 9.4 | 7.4 | 4.6 |
| (meq/g) | 1.03 | 0.86 | 0.58 |

II.1.2—by Modifying a 1,3-Butadiene, Styrene and Glycidyl Methacrylate Copolymer Through Reaction with 3,4-Dihydroxyhydrocinnamic Acid:

In advance, the 1,3-butadiene, styrene and glycidyl methacrylate copolymers D and E respectively are prepared by free-radical polymerization according to the following protocol:

Radical emulsion polymerization is carried out in a capped bottle with moderate stirring and under an inert nitrogen atmosphere.

K₂S₂O₈ and hexadecyltrimethylammonium chloride are introduced into a bottle. The bottle is capped and then sparged with nitrogen for 10 min. The following compounds and solutions (these solutions having been sparged beforehand to remove any trace of oxygen) are subsequently successively introduced into the bottle in the contents indicated in Table 3.
water
100 g/L HPO₄Na₂ solution (HPO₄Na₂ solution)
100 g/L H₂PO₄NH₄ solution (H₂PO₄NH₄ solution)
0.7 mol/L solution of tert-dodecylmercaptan in styrene (tert-dodecylmercaptan solution)
styrene
glycidyl methacrylate
1,3-butadiene

The reaction medium is stirred and heated at 40° C. The polymerization is halted after 60% conversion by the addition of 1 mL of a 100 g/L solution of resorcinol in water.

The copolymer is precipitated from an acetone/methanol (50/50 v/v) mixture.

The copolymer is dried by placing in an oven under vacuum (200 torr) at 50° C.

The quantities of reagents, compounds and solutions are indicated in Table 3 for each of the copolymers D and E.

TABLE 3

| Copolymer | D | E |
|---|---|---|
| K₂S₂O₈ (g) | 0.12 | 0.3 |
| hexadecyltrimethylammonium chloride | 0.5 | 1.25 |
| (g) | | |
| water (g) | 90 | 225 |
| HPO₄Na₂ solution (mL) | 4.5 | 11.2 |
| H₂PO₄NH₄ solution (mL) | 1.9 | 4.7 |
| tert-dodecylmercaptan solution (mL) | 0.44 | 1.1 |
| styrene (mL) | 2. | 5.2 |
| 1,3-butadiene (mL) | 9.5 | 23.8 |
| Glycidyl methacrylate (mL) | 1.9 | 4.6 |

Table 3b indicates the microstructure of copolymers D and E prepared, expressed in molar percentage.

TABLE 3b

| Copolymer | D | E |
|---|---|---|
| 1,3-butadiene | 78 | 76 |
| MAGLY | 9 | 10 |

Copolymer D or E is then modified by reaction with a compound carrying a 3,4-dihydroxyaryl group, 3,4-dihydroxyhydrocinnamic acid according to the following protocol:

In a three-necked round-bottomed flask with a condenser, the 1,3-butadiene, styrene and glycidyl methacrylate copolymer is solubilized in dioxane. 3,4-dihydroxyhydrocinnamic acid (10 equivalents with respect to the number of moles of epoxide functional groups) is added. The reaction medium is then stirred under mechanical stirring and heated at 110° C. under an inert atmosphere for 72 h. The reaction medium is subsequently allowed to return to ambient temperature under an inert atmosphere and then the polymer is coagulated from water and dried by placing in an oven under vacuum (200 torr) at 60° C.

The quantities of reagents and solvents used in the reaction to modify copolymers D and E by 3,4-dihydroxyhydrocinnamic acid are indicated in Table 4. Also in Table 4 are the microstructure and macrostructure of the modified copolymers, respectively DF and EF.

TABLE 4

| Functional diene polymer | DF | EF |
|---|---|---|
| Copolymer C (g) | 3.06 | 0 |
| Copolymer D (g) | 0 | 3.04 |
| 3,4-dihydroxyhydrocinnamic acid (g) | 5.06 | 5.02 |
| Dioxane (mL) | 30 | 30 |
| Mn | 29000 | 54500 |
| Mw | 260140 | 634290 |
| 3,4-dihydroxyaryl group | | |
| (mol %) | 8.9 | 5.8 |
| (meq/g) | 1.05 | 0.71 |

II.1.3—by Modification of Epoxidized Polyisoprene Through Reaction with a Nucleophilic Compound Carrying Both the 3,4-Dihydroxyaryl Group and a Nucleophilic Function, 11-[ethoxy(hydroxy)phosphoryl]undecyl 3-(3,4-dihydroxyphenyl)propanoate:

For the modification reaction, either a synthesized epoxidized polyisoprene or an epoxidized natural rubber is used. The synthesized epoxidized polyisoprene is prepared by epoxidation of a synthetic polyisoprene:

Protocol for the Preparation of the Synthetic Polyisoprene:

In a 250 mL reactor held under nitrogen pressure of 2 bar, containing 105 mL of methylcyclohexane, is injected 10.21 g of isoprene. 4.5 mL of n-butyllithium at 1.34 mol/L are then added. The medium is heated at 50° C. for 45 min to reach a monomer conversion rate of 95%. This content is determined by weighing an extract dried at 110° C. under a reduced pressure of 200 mmHg. The polymerization is stopped by adding excess methanol relative to the lithium. The polymer solution is filtered to remove lithine residue present in the medium. Finally, the polymer solution is subjected to an antioxidant treatment by addition of 0.2 parts per hundred parts of polymer of 4,4′-methylenebis(2,6-tert-butylphenol) and 0.2 parts per hundred parts of polymer of N-(1,3-dimethylbutyl)-N′-phenyl-p-phenylenediamine, then the polymer is dried in the oven under vacuum at 60° C. for 2 days. The polyisoprene has a mean molar mass by mass of 3,000 g/mol, a polydispersity index (PI) of 1.06, and 88 mol % of 1,4-cis bonding.

Protocol for Epoxidation of the Synthetic Polyisoprene:

In a three-necked round-bottomed flask, the synthetic polyisoprene is dissolved to a mass concentration of 6% in methylcyclohexane. The mixture is stirred and heated to 35° C.; formic acid (1 equivalent relative to the number of moles of isoprene units to be epoxidized) is then added. The mixture is then heated at 47° C., then hydrogen peroxide (1 equivalent relative to the number of moles of isoprene units to epoxidize) is added dropwise using an addition funnel. The medium is then heated at 50° C. for 4 hours. At the end of the reaction, the medium is neutralized by adding a solution of aqueous sodium hydroxide (1 equivalent relative to the number of moles of formic acid added). The reaction medium is then washed three times with water using a separating funnel. The organic phase is then dried over MgSO₄, then filtered. The epoxidized polymer is recovered by drying the organic phase in an oven at 45° C. for 48 hours. The epoxidation level is 8.4 mol %.

The epoxidized synthetic polyisoprene, hereinafter called G, is then modified by reaction with a compound carrying a 3,4-dihydroxyaryl group, 11-[ethoxy(hydroxy)phosphoryl]undecyl 3-(3,4-dihydroxyphenyl)propanoate according to the following protocol:

15 g of E, 9.71 g of 11-[ethoxy(hydroxy)phosphoryl]undecyl 3-(3,4-dihydroxyphenyl)propanoate and 170 mL of dioxane are introduced into a single-necked round-bottomed flask. The reaction medium is stirred and heated at 90° C. for 20 hours. At the end of the reaction, the dioxane is removed using the rotary evaporator. The resulting substance is dissolved in 200 mL of dichloromethane, the medium is stirred then a 1 M solution of NaHCO₃ in water is added (1 equivalent relative to the number of moles of 11-[ethoxy(hydroxy)phosphoryl]undecyl 3-(3,4-dihydroxyphenyl)propanoate). The medium is stirred for 1 h then an extraction is done using a separating funnel and a mixture of saline water/acetone. The organic phase is then dried over MgSO₄, then filtered. The modified polymer, hereinafter called GF, is recovered by drying the organic phase in the oven at 45° C. for 48 hours. Table 5 shows the microstructure and macrostructure of the modified polymer, GF.

The epoxidized natural rubber, hereinafter called H, is natural rubber with epoxide groups dispersed randomly along the main polymer chain, sold under the name “Ekoprena”; its molar epoxidation level is 25%, its Mooney viscosity 75±15.

It is then modified by reaction with a compound carrying a 3,4-dihydroxyaryl group, 11-[ethoxy(hydroxy)phosphoryl]undecyl 3-(3,4-dihydroxyphenyl)propanoate according to the following protocol:

20 g of G, 6.04 g of 11-[ethoxy(hydroxy)phosphoryl]undecyl 3-(3,4-dihydroxyphenyl)propanoate and 500 mL of toluene are added to a single-necked round-bottomed flask. The reaction medium is stirred magnetically and heated at 90° C. for 24 hours. At the end of the reaction, the modified polymer, hereinafter called HF, is dried in the oven, then stirred in 1 L of ethanol for 24 hours. After filtration, the modified polymer is dried in the oven at 60° C. for 8 hours.

Table 5 shows the microstructure and macrostructure of the modified polymer, HF.

TABLE 5

| Functional diene polymer | GF | HF |
|---|---|---|
| Mn | 2600 | >150000 |
| Mw | 4500 | >650000 |
| di hydroxyaryl group | | |
| (mol %) | 4.7 | 4 |
| (meq/g) | 0.54 | 0.48 |

II.1.4—by Modifying an α,ω-Dihydroxylated Polybutadiene Through Reaction with a Compound Carrying Both the 3,4-Dihydroxyaryl Group and Carrying an Electrophilic Function, 3,4-Dihydroxyhydrocinnamic Acid:

The α,ω-dihydroxylated polybutadiene used in the modification reaction is PolyBd R20 LM by Cray Valley and is hereinafter called J. It is modified according to the following protocol:

20.0 g of PolyBd R20 LM, 8.05 g (2.6 eq) of 3,4-dihydroxyhydrocinnamic acid, 0.42 g (0.1 eq) of p-toluenesulfonic acid and 250 mL of toluene are added to a single-necked round-bottomed flask. The round-bottomed flask is equipped with a Dean and Stark apparatus and then the mixture is stirred at 140° C. for 48 hours.

At the end of the reaction, the toluene is removed by evaporation under vacuum. The telechelic polybutadiene is then dissolved in dichloromethane; two successive aqueous extractions make it possible to remove the excess 3,4-dihydroxyhydrocinnamic acid and also the p-toluenesulfonic acid. The dichloromethane phase is dried over anhydrous sodium sulfate. The dichloromethane is subsequently removed by evaporation under vacuum. Table 6 shows the microstructure and macrostructure of the modified polymer, JF.

TABLE 6

| Functional diene polymer | JF |
|---|---|
| Mn | 3750 |
| Mw | 29100 |
| dihydroxyaryl group | |
| (mol %) | 1.8 |
| (meq/g) | 0.46 |

### II.2—Preparation of the Rubber Compositions:

The rubber compositions prepared are distinguished by the polymer matrix, because of the microstructure, macrostructure and functional diene polymer content used in the polymer matrix. For all of the rubber compositions, the polymer matrix consists of a mixture of natural rubber and functional diene polymer, the functional diene polymer representing 10, 15 or 25% by mass of the polymer matrix. The functional diene polymer used in the polymer matrix, and its content, are indicated in Tables 7 to 9.

To prepare the rubber composition, a reinforcing filler is incorporated into the polymer matrix, a carbon black (N326), and a crosslinking system, a peroxide (dicumyl peroxide) according to the protocol described hereinafter. The carbon black content is 50 parts per 100 parts of polymer matrix, the peroxide content 5 parts per 100 parts of polymer matrix.

The natural rubber, the carbon black and the functional diene polymer are added to an internal mixer (final degree of filling: approximately 70% by volume), where the initial vessel temperature is approximately 60° C. Thermomechanical working is then carried out (non-productive phase) until a maximum “dropping” temperature of approximately 150° C. is reached. The resulting mixture is recovered and cooled and then the crosslinking system is added on an external mixer (homofinisher) at 30° C., everything being mixed (productive phase).

### II.3—Test Specimen Preparation:

The quality of the bonding between the rubber composition and the reinforcer is determined by a test in which the force necessary to extract the reinforcer from the crosslinked rubber composition is measured. The reinforcer is presented in the form of sections of individual threads. For this purpose, test specimens are prepared containing first individual metal reinforcer threads presenting a metallic surface and secondly a crosslinked rubber composition.

The rubber compositions described in paragraph 11.2 are used to make test specimens according to the following protocol:

A block of rubber is made, constituted of two plates applied to each other before curing. The two plates of the block consist of the same rubber composition. It is during the production of this block that the individual threads are trapped between the two sheets in the raw state, an equal distance apart and while leaving to protrude, on either side of these sheets, an individual thread end having a length sufficient for the subsequent tensile test. The block including the individual threads is then placed in a mould adapted to the targeted test conditions and left to the discretion of a person skilled in the art; by way of example, in the present case, the block is cured at 160° C. for a time varying from 25 min to 60 min according to the composition under a pressure of 5.5 tonnes.

The individual threads are plain (i.e. non-coated) steel or steel coated with brass or bronze. Their diameter is 1.75 mm, apart from bronzed threads for which the diameter is 1.30 mm; the thickness of the brass coating is 200 nm to 1 μm, the thickness of the bronze coating is 50 nm to 0.1 μm.

For each of the resulting test specimens prepared, Tables 7 to 9 indicate:
where functional diene polymers AF, BF, CF, DF, EF, GF, HF and JF were used
the mass fraction of functional diene polymer in the polymer matrix
the metal of the metallic surface of the individual thread.

Each test specimen is referenced by a numeral followed by a lower case letter, for example 1a. One number corresponds to one functional diene polymer. The lower case letter indicates the nature of the metal of the metallic surface of the individual thread: a for brass, b for steel and c for bronze.

The resulting test specimens prepared correspond to the use of rubber compositions in accordance with embodiments of the invention.

### II.4—Results:

### Adhesion Test:

On conclusion of the curing, the resulting test specimen consisting of the crosslinked block and individual threads is placed between the jaws of a suitable tensile testing machine in order to make it possible to test each section individually, at a given rate and a given temperature (for example, in the present case, at 100 mm/min and ambient temperature).

The adhesion levels are characterized by measuring the “tearing-out” force for tearing the sections out of the test specimen.

The results are expressed in base 100 relative to a control specimen that contains individual threads identical to the test specimen and that contains a rubber composition, called a control, whose polymer matrix consists of natural rubber (in other words the mass fraction of the functional diene polymer in the polymer matrix is 0% in the control rubber composition).

Apart from the absence of functional diene polymer, the control rubber composition is manufactured according to the same protocol as the rubber compositions of embodiments of the invention. The control test specimen is prepared according to the same protocol as the other test specimens.

A value greater than that for the control test specimen, arbitrarily set at 100, indicates an improved result, that is to say, a greater tearing-out force than that for the control test specimen. The values for the tearing-out forces in base 100 resulting from the tests conducted on the test specimens are summarized in Tables 7 to 9, according to the level of functional diene polymer in the polymer matrix and according to the nature of the individual threads.

TABLE 7

| | Test specimen | | | | | |
|---|---|---|---|---|---|---|
| | 1a and | 2a and | 3a and | 4a and | 5a and | 6a and |
| | 1b | 2b | 3b | 4b | 5b | 6b |
| Mass fraction | AF | BF | DF | EF | HF | JF |
| 10% | | | | | | |
| brass | 3360 | 2320 | 2480 | 900 | 220 | 240 |
| steel | 2780 | 2840 | 3480 | 1460 | 1240 | 3160 |

TABLE 8

| | Test specimen | | | |
|---|---|---|---|---|
| | | | 9a, 9b and | 10a, 10b and |
| | 7a and 7b | 8a and 8b | 9c | 10c |
| Mass fraction 15% | BF | CF | GF | JF |
| brass | 2100 | 3240 | 980 | 560 |
| steel | 3300 | 2400 | 2700 | 3940 |
| bronze | | | 2360 | 1740 |

TABLE 9

| Test specimen | 11a and 11b | 12a and 12b |
|---|---|---|
| Mass fraction 25% | AF | CF |
| brass | 2320 | 2920 |
| steel | 2600 | 1920 |

Presenting values much higher than 100 in the adhesion test, the test specimens containing a composition in accordance with embodiments of the invention exhibit greatly improved tearing-out force, equally well for thread elements made of steel as for those made of brass and of bronze, i.e. comprising iron, copper, zinc or tin.

The improved tearing-out resistance is observed for all the rubber compositions regardless of the microstructure and macrostructure of the functional diene polymers:
Indeed the improvement is observed regardless of the position of the aromatic group substituted by at least 2 vicinal hydroxyl functions: in polymer JF, the aromatic group is carried at the chain end; in polymers AF, BF, CF, DF, EF, GF and HF, it is outside the chain ends;
The improvement is observed when the functional diene polymer is a polybutadiene (JF), a butadiene copolymer (DF and EF), a polyisoprene (GF and HF) or an isoprene copolymer (AF, BF and CF);
The improvement is observed for a wide range of number-average molar masses for the functional diene polymer, ranging from a few thousand (AF, BF, CF, DF and JF) to several tens of thousands (DF and EF), or a few hundreds of thousands (HF).

It is also remarkable to note that the improvement in the adhesion between the metal and the rubber composition is observed in the absence of any sulfuration step, generally necessary in the manufacturing of composites based on diene elastomers and steel or brass or bronze.

1. A rubber composition based on at least one polymer matrix including a diene elastomer Ed and a functional diene polymer that carries at least one aromatic group substituted by at least two hydroxyl functions, where the diene elastomer Ed represents more than 50% by mass of the polymer matrix, and the functional diene polymer represents at most 30% by mass of the polymer matrix and two of the hydroxyl functions are vicinal.

2. A rubber composition according to claim 1, wherein the functional diene polymer carries several aromatic groups substituted by at least two hydroxyl functions, where two of the hydroxyl functions are vicinal.

3. A rubber composition according to claim 1, wherein the two vicinal hydroxyl functions are respectively in the meta and para positions relative to the bond or the group that ensures the attachment of the aromatic group to the chain of the functional diene polymer.

4. A rubber composition according to claim 1, wherein the hydroxyl functions of the aromatic group are two in number.

5. A rubber composition according to claim 1, wherein the aromatic group is a dihydroxyaryl group having formula (I), where the symbol * represents a direct or indirect attachment to the chain of the functional diene polymer.

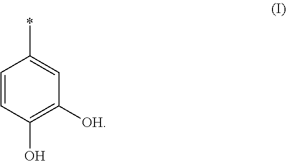 [SMILES: *c1ccc(O)c(O)c1]

6. A rubber composition according to claim 1, wherein the aromatic group is a pendant group of the polymer chain of the functional diene polymer.

7. A rubber composition according to claim 1, wherein the aromatic group is at the end of the polymer chain of the functional diene polymer.

8. A rubber composition according to claim 1, wherein the aromatic group is exclusively carried at a single end or on each end of the polymer chain of the functional diene polymer.

9. A rubber composition according to claim 1, wherein the aromatic group is outside the ends of the polymer chain of the functional diene polymer.

10. A rubber composition according to claim 1, wherein the aromatic group content in the functional diene polymer is from 0.01 to 3 milliequivalents per g (meq/g).

11. A rubber composition according to claim 1, wherein the functional diene polymer is an elastomer.

12. A rubber composition according to claim 1, wherein the functional diene polymer has a number-average molar mass ranging from 1,000 g/mol to 80,000 g/mol.

13. A rubber composition according to claim 1, wherein the functional diene polymer is selected from the group of polymers constituted by polybutadienes, polyisoprenes, 1,3-butadiene copolymers, isoprene copolymers and mixtures thereof.

14. A rubber composition according to claim 1, wherein the diene elastomer Ed is selected from the group of highly unsaturated elastomers constituted by polybutadienes, polyisoprenes, 1,3-butadiene copolymers, isoprene copolymers and mixtures thereof.

15. A rubber composition according to claim 1, wherein the diene elastomer Ed is a polyisoprene having more than 90% by mass of 1,4-cis bond.

16. A rubber composition according to claim 1, wherein the functional diene polymer represents between 5 and 30% by mass of the polymer matrix.

17. A rubber composition according to claim 1, wherein the diene elastomer Ed and the functional diene polymer represent at least 90% by mass of the polymer matrix.

18. A rubber composition according to claim 1, wherein the polymer matrix consists of the diene elastomer Ed and the functional diene polymer.

19. A rubber composition according to claim 1, which composition comprises a reinforcing filler.

20. A rubber composition according to claim 19, wherein the reinforcing filler is a carbon black.

21. A rubber composition according to claim 19, wherein the reinforcing filler content is within a range extending from 20 to 80 parts per hundred parts of the polymer matrix.

22. A rubber composition according to claim 1, which further comprises a crosslinking system.

23. A semi-finished article including reinforcement elements with a metallic surface intended to come into contact with the rubber composition, which reinforcement elements are coated in the rubber composition defined in claim 1.

24. A semi-finished article according to claim 23, which article is a reinforcing reinforcer for tires.

25. A tire comprising a semi-finished article defined in claim 23.
